(19) United States
(12) Patent Application Publication
(10) Pub. No.: US 2006/0072836 A1
(43) Pub. Date: Apr. 6, 2006

(54) Arbitrary quantization step number encoding and decoding apparatus and method

(76) Inventors: Shao-Shi Chen, Daya Township (TW); Hung-Wen Chen, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/242,006

(22) Filed: Oct. 4, 2005

(30) Foreign Application Priority Data
Oct. 6, 2004 (TW) 093130267

(51) Int. Cl. G06K 9/36

(52) U.S. Cl. 382/232

(57) ABSTRACT

An arbitrary step number is used in an encoding apparatus and method to encode an input data, or in a decoding apparatus and method to decode an input code. The arbitrary step number is an even number and greater than one, so that arbitrary compression ratio is available. In association with a lossless encoder further in the encoding apparatus and method, an optimum compression ratio is obtained.

### FIELD OF THE INVENTION

The present invention is related generally to a pulse code modulation (PCM) encoding and decoding apparatus and method, and more particularly, to an arbitrary quantization step number encoding and decoding apparatus and method.

### BACKGROUND OF THE INVENTION

Pulse code modulation (PCM) is a well-known technique that aids the processing of digital signal and the operation of digital system. Differential PCM (DPCM) is also a popular technique applied to help reduce the distortion resulted from quantization and cut down the capacity of digital encoding. Further, adaptive DPCM (ADPCM) enhances the efficiency and quality of signal processing by adjusting the quantization scale based on the variation in signal level. FIG. 1 is a block diagram of a typical ADPCM encoder 100, in which prediction error Ue is obtained by subtracting prediction value û from input data u, quantizer 102 generates output code Que based on a fixed code length, a fixed quantization step number, a step size Δ provided by delta adaptor 104, and the prediction error Ue, the delta adaptor 104 adjusts the step size Δ based on the output code Que, and inverse-quantizer 106 transforms the output code Que to quantized prediction error Iue to combine with the prediction value û to produce quantization data Qu for predictor 108 to determine the prediction value û for the next data u. FIG. 2 is a block diagram of a typical ADPCM decoder 200, in which inverse-quantizer 204 transforms input code Que to quantized prediction error Iue based on a fixed code length, a fixed quantization step number, and a step size Δ provided by delta adaptor 202 based on the input data Que, predictor 206 provides prediction value û to combine with the quantized prediction error Iue to recover the coded data Qu for output, and the predictor 206 generates the prediction value û for the next quantized prediction error Iue based on the output data Qu.

Such adaptive step size design addresses the problem of excessive signal amplitude, while it tends to increase the quantization error. Taiwanese Patent Issue No. 453,048 introduces resolution adaptor to DPCM and ADPCM system to adjust the encoding and decoding resolution, i.e., the bit rate of the generated code, based on the output of the delta adaptor and quantized differential code Que to reduce distortion and increase compression ratio. However, constrained by the quantization bit rate, which limits the quantization step number to power of two, the compression ratio can only be the ratio of the bit rate of the data u to that of the code Que. As shown in Table 1, such restriction limits the application of this system configuration to the design of certain special compression ratio, for example, when the system requires compression ratio of six. In reference to Table 1, a conventional encoding and decoding apparatus and method cannot provide the compression ratio of six, so that the designer only has the alternative of using the compression ratio of eight. Unfortunately, higher compression ratio results in more serious data distortion.

TABLE 1

| Bit rate of | Bit rate of | Compression | Quantization |
|---|---|---|---|
| data u | code Que | ratio | step number |
| 16 | 2 | 8 | 4 |
| 16 | 3 | 5.333 | 8 |
| 16 | 4 | 4 | 16 |
| 16 | 5 | 3.2 | 32 |
| 16 | 6 | 2.667 | 64 |
| 32 | 4 | 8 | 16 |
| 64 | 4 | 16 | 16 |
| 128 | 4 | 32 | 16 |

Therefore, it is desired an encoding and decoding apparatus and method for arbitrary compression ratio.

### SUMMARY OF THE INVENTION

One object of the present invention is to provide an arbitrary quantization step number encoding and decoding apparatus and method.

Another object of the present invention is to provide an encoding and decoding apparatus and method for arbitrary compression ratio.

In an arbitrary quantization step number encoding apparatus and method, according to the present invention, a predictor provides a prediction value to compare with an input data to obtain an prediction error, and a quantizer quantizes the prediction error based on a quantization step number and a step size to generate an output code, wherein the quantization step number is an even number and greater than one.

In an arbitrary quantization step number decoding apparatus and method, according to the present invention, an inverse-quantizer transforms an input code to a quantized prediction error based on a quantization step number and a step size, and the quantized prediction error is combined with a prediction value provided by a predictor to produce an output data, wherein the quantization step number is an even number and greater than one.

According to the present invention, the quantization step number used by encoding and decoding apparatus and method is not confined to power of two, thereby offering more flexibility in the design of compression ratio and allowing the design of optimum compression ratio for different applications.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a block diagram of a typical ADPCM encoder system;

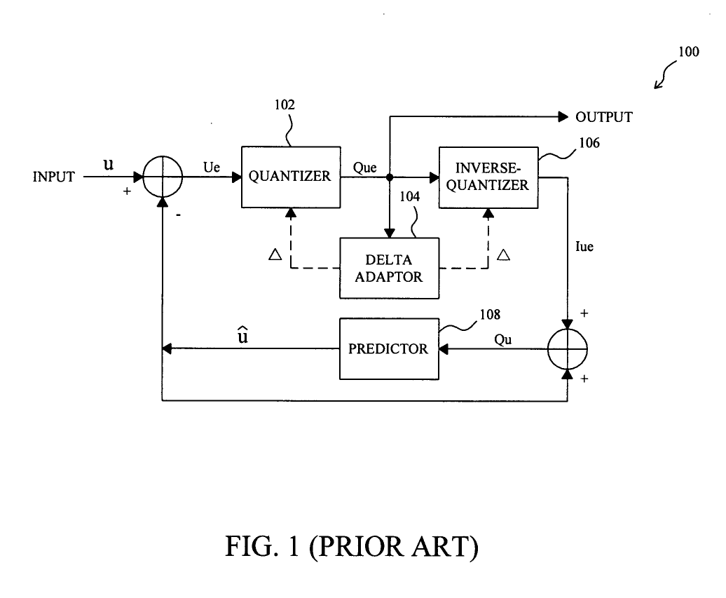

FIG. 2 is a block diagram of a typical ADPCM decoder system;

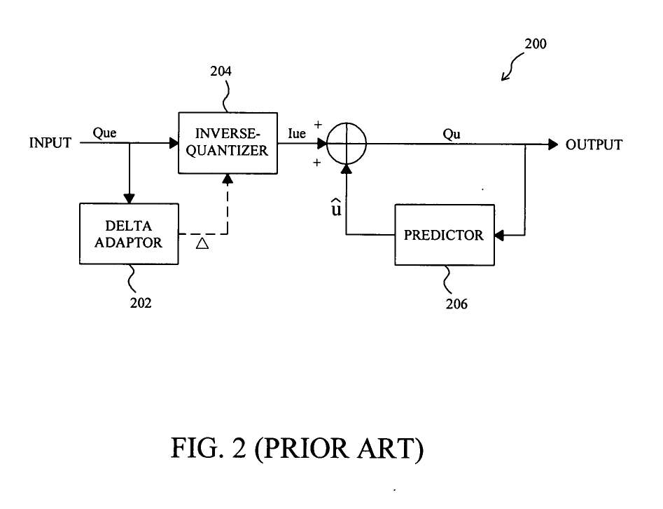

FIG. 3 is a block diagram of an arbitrary quantization step number encoding apparatus according to the present invention; and

FIG. 4 is a block diagram of an arbitrary quantization step number decoding apparatus according to the present invention.

### DETAILED DESCRIPTION OF THE INVENTION

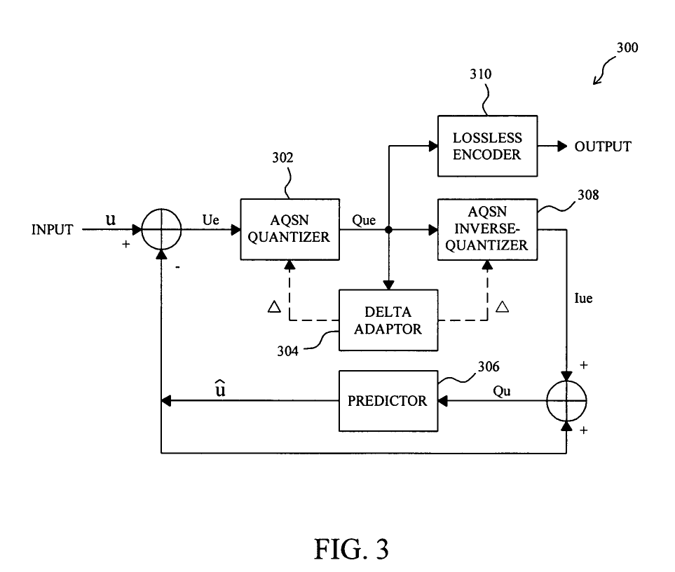

FIG. 3 shows a block diagram of an arbitrary quantization step number encoding apparatus 300 according to the present invention, in which prediction error Ue is obtained by subtracting prediction value û from input data u, arbitrary quantization step number quantizer 302 generates output code Que based on a quantization step number that is an even number and greater than one, a step size Δ provided by delta adaptor 304, and the prediction error Ue, the delta adaptor 304 adjusts the step size Δ based on the output code Que, arbitrary quantization step number inverse-quantizer 308 transforms the output code Que with the same quantization step number and step size Δ to produce quantized prediction error Iue to combine with the prediction value û to produce quantized data Qu, predictor 306 receives the quantized data Qu and based on which to produce the prediction value u for the next input data u, and prior to the sending of the output code Que, lossless encoder 310 is employed to recompress the output code Que to obtain different compression ratio for different applications.

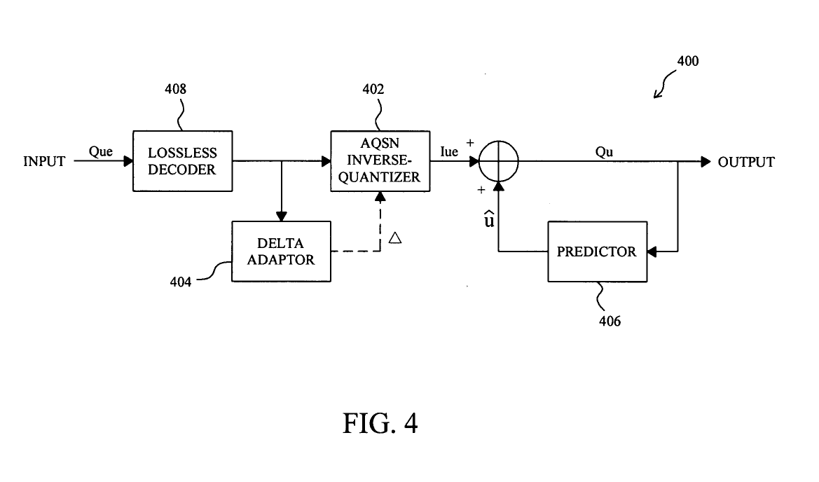

FIG. 4 shows a block diagram of an arbitrary quantization step number decoding apparatus 400 according to the present invention, in which arbitrary quantization step number inverse-quantizer 402 transforms input code Que to produce quantized prediction error Iue based on a quantization step number that is an even number and greater than one, and a step size Δ provided by delta adaptor 404, the delta adaptor 404 adjusts the step size Δ based on the input code Que, predictor 406 provides prediction value û to combine with the quantized prediction error Iue to produce output data Qu, and the predictor 406 determines the next prediction value û based on the output data Qu. If the code Que was compressed by lossless encoder during the encoding process, lossless decoder 408 is introduced in the decoding apparatus 400 to decompress the input code Que before it is inputted into the arbitrary quantization step number inverse-quantizer 402.

Table 2 shows an example of the present invention. By comparing Table 2 with Table 1, it is illustrated that in a conventional encoding and decoding apparatus and method, because the quantization step number is power of two, only one compression ratio is available when the bit rate of the data u and code Que are constant, while in an encoding and decoding apparatus and method of the present invention, more than one compression ratio are available owing to the fact that the quantization step number is not confined to power of two. Furthermore, with the use of lossless encoder and decoder, various compression ratios may be achieved for different applications.

TABLE 2

| Bit rate of | Bit rate of | Lossless | Compression | Quantization |
|---|---|---|---|---|
| data u | code Que | compression | ratio | step number |
| 16 | 4 | 1 | 4.999 | 10 |
| 16 | 4 | 1 | 4.666 | 12 |
| 16 | 4 | 1 | 4.333 | 14 |
| 16 | 4 | 1 | 4 | 16 |
| 16 | 4 | 0.9 | 5.499 | 10 |
| 16 | 4 | 0.9 | 5.132 | 12 |
| 16 | 4 | 0.9 | 4.766 | 14 |
| 16 | 4 | 0.9 | 4.4 | 16 |

In Taiwanese Patent Issue No. 453,048, additional circuit is used to adjust the bit rate for changing the compression ratio. The present invention does not require the use of additional circuit, thereby reducing the required chip size. However, if desired, the present invention can be also combined with additional circuit to adjust the bit rate.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof of the appended claims.

What is claimed is:

1. An arbitrary quantization step number encoding apparatus, comprising:
a predictor for providing a prediction value to compare with an input data to obtain a prediction error; and
a quantizer for quantizing the prediction error based on a quantization step number and a step size to produce an output code;
wherein the quantization step number is an even number and greater than one.

2. The apparatus according to claim 1, further comprising a delta adaptor for adjusting the step size based on the output code.

3. The apparatus according to claim 1, further comprising a lossless encoder for recompressing the output code.

4. The apparatus according to claim 1, further comprising an inverse-quantizer for transforming the output code based on the quantization step number and step size to produce a quantized prediction error.

5. The apparatus according to claim 4, wherein the predictor produces a prediction value for a next input data based on the quantized prediction error and current prediction value.

6. An arbitrary quantization step number encoding method, comprising the steps of:
comparing a prediction value and an input data for producing a prediction error; and
quantizing the prediction error based on a quantization step number and a step size for producing an output code;
wherein the quantization step number is an even number and greater than one.

7. The method according to claim 6, further comprising the step of dynamically adjusting the step size based on the output code.

8. The method according to claim 6, further comprising the step of recompressing the output code.

9. The method according to claim 6, further comprising the steps of:
transforming the output code based on the quantization step number and step size for producing a quantized prediction error; and
producing a prediction value for a next input data based on the quantized prediction error and current prediction value.

10. An arbitrary quantization step number decoding apparatus, comprising:
an inverse-quantizer for transforming an input code based on a quantization step number and a step size to produce a quantized prediction error; and
a predictor for providing a prediction value to combine with the quantized prediction error to produce an output data;
wherein the quantization step number is an even number and greater than one.

11. The apparatus according to claim 10, further comprising a lossless decoder for decompressing the input code before it is inputted into the inverse-quantizer.

12. The apparatus according to claim 10, further comprising a delta adaptor for adjusting the step size based on the input code.

13. The apparatus according to claim 10, wherein the predictor determines a next prediction value based on the output data.

14. An arbitrary quantization step number decoding method, comprising the steps of:
transforming an input code based on a quantization step number and a step size for producing a quantized prediction error; and
combining a prediction value with the quantized prediction error for producing an output data;
wherein the quantization step number is an even number and greater than one.

15. The method according to claim 14, further comprising the step of decompressing the input code before it is transformed to the quantized prediction error.

16. The method according to claim 14, further comprising the step of dynamically adjusting the step size based on the input code.

17. The method according to claim 14, further comprising the step of determining a next prediction value based on the output data.
